(19) United States
(12) Patent Application Publication
(10) Pub. No.: US 2022/0059886 A1
(43) Pub. Date: Feb. 24, 2022

(54) VEHICLE ELECTRIC BATTERY

(71) Applicant: FAURECIA SYSTEMES D'CHAPPEMENT, Nanterre (FR)

(72) Inventor: Frédéric GRÉBER, Ecot (FR)

(21) Appl. No.: 17/421,194

(22) PCT Filed: Jan. 10, 2020
(86) PCT No.: PCT/EP2020/050588

§ 371 Date: Jul. 7, 2021

(30) Foreign Application Priority Data
Jan. 10, 2019 (FR) 19 00228

(51) Int. Cl. H01M 10/6568; H01M 10/6557; H01M 10/613; H01M 50/249; H01M 10/647; H01M 10/625; H01M 50/209; B60L 58/26; B60L 50/64

(52) U.S. Cl. CPC H01M 10/6568; H01M 10/6557; H01M 10/613; H01M 50/249; H01M 2220/20; H01M 10/625; H01M 50/209; B60L 58/26; B60L 50/64; H01M 10/647

(57) ABSTRACT

The electric battery comprises
a plurality of electricity storage cells arranged inside a sealed compartment;
a dielectric fluid filling the sealed compartment;
at least one fluid guide made from low-density plastic and arranged inside the sealed compartment, the fluid guide defining at least one flow channel for the dielectric fluid in contact with the electricity storage cells; and
a device for circulating the dielectric fluid.

The invention relates generally to electricity storage batteries, particularly for motor vehicles.

It is possible to equip motor vehicles with electric batteries comprising a large number of prismatic electricity storage cells. These electricity storage cells can be cooled by immersing them in a dielectric fluid.

The use of a dielectric fluid allows direct cooling of the live parts without interfering with the operation of these parts, as the electrical conductivity of the fluid is zero. This type of cooling is very efficient and can obtain good exchange densities. It can also be used to cool large surfaces.

Indirect contact cooling systems, by comparison, do not usually cool the entire surface of the heat-emitting part. In such a system, it is usual to only cool the most accessible and warmest part. This inevitably leads to undesired temperature gradients.

In particular, in the case of air cooling, the density of the heat exchange is extremely low, even if convection is forced by ventilation.

On the other hand, cooling by means of a dielectric fluid has the disadvantage that it is expensive, especially since the price of the dielectric fluid is high.

In this context, the invention aims to provide an electric battery with highly efficient cooling at a reasonable cost.

To this end, the invention relates to an electric battery for a vehicle, comprising:
a container, internally delimiting a sealed compartment.
a plurality of electricity storage cells arranged inside the sealed compartment, the electricity storage cells having respective electrodes.
a dielectric fluid filling the sealed compartment.
at least one fluid guide made of a low-density plastic material arranged inside the sealed compartment, the fluid guide defining at least one flow channel for the dielectric fluid in contact with the electricity storage cells.
a device for circulating the dielectric fluid.

The fluid guide makes it possible to organize the circulation of the dielectric fluid in such a way as to direct it towards the hottest zones, which must be cooled as a priority. It also allows an efficient circulation of the fluid inside the container to be organized, without dead zones where the fluid circulation would remain very weak.

The volume occupied by the fluid guide reduces the amount of dielectric fluid needed to fill the container. This reduces the total cost of the electric battery.

The circulation of the fluid is ensured by a device provided for this purpose, so that the movement of the fluid is ensured in an efficient manner. Moreover, the fluid flow rate, i.e., the speed of circulation of the fluid in contact with the electricity storage cells, can be modulated by adjusting the cross-section of the circulation channels.

The electric battery can furthermore present one or more of the following features, considered individually or according to any technically possible combination:
the sealed compartment comprises an internal volume, the plurality of electricity storage cells occupying an occupied volume, a remaining volume being equal to the internal volume minus the occupied volume, the at least one fluid guide occupying at least 30% of the remaining volume.
the low-density plastic is a foam or an expanded plastic material.
the electricity storage cells are distributed in one or more modules, the electricity storage cells of the same module being juxtaposed longitudinally and having a front face.
the at least one flow channel comprises at least one electrode cooling channel, directing the dielectric fluid into contact with the electrodes of the electricity storage cells.
the electricity storage cells of the same module each have an elongated front face in an elevation direction and carry the electrodes of the said electricity storage cell, the front faces together constituting the front face, the at least one flow channel comprising lateral branches extending from the or each electrode cooling channel in the elevation direction and directing the dielectric fluid into contact with the front face of the electricity storage cells.
the electric battery comprises, for each module, a circuit board configured to balance an electrical load of the electricity storage cells of the said module, arranged opposite the front face of the module, the at least one flow channel comprising at least one circuit board cooling channel, directing the dielectric fluid into contact with at least one of the circuit boards.
the battery comprises two modules whose respective front faces are arranged transversely opposite each other and delimit a gap between them, the fluid guide forming a spacer defining a transverse width of the gap.
the container comprises a bin and a lid tightly assembled to the bin, the bin and/or the lid carrying a plurality of longitudinal ribs blocking in translation the modules perpendicular to the longitudinal direction.
the battery comprises at least one filler piece made of a low-density plastic material, arranged inside the sealed compartment in the remaining volume so as to reduce the volume of dielectric fluid required to fill the sealed compartment.

According to another aspect, the invention relates to a vehicle comprising an electric battery having the above features, for example configured to electrically power an electric motor for propulsion of the vehicle.

According to yet another aspect, the invention relates, in an electric battery comprising:
a container, internally delimiting a sealed compartment.
a plurality of electricity storage cells arranged inside the sealed compartment.
a dielectric fluid filling the sealed compartment.
a device for circulating the dielectric fluid.

on the use of a part made of a low-density plastic material, arranged inside the sealed compartment, to reduce the volume of dielectric fluid required to fill the sealed compartment.

This part is for example the fluid guide described above. Alternatively, it is another part, which may or may not be used to channel the flow of dielectric fluid.

Other features and advantages of the invention will be apparent from the detailed description given below, by way of indication and not in any way limiting, with reference to the attached figures, among which:

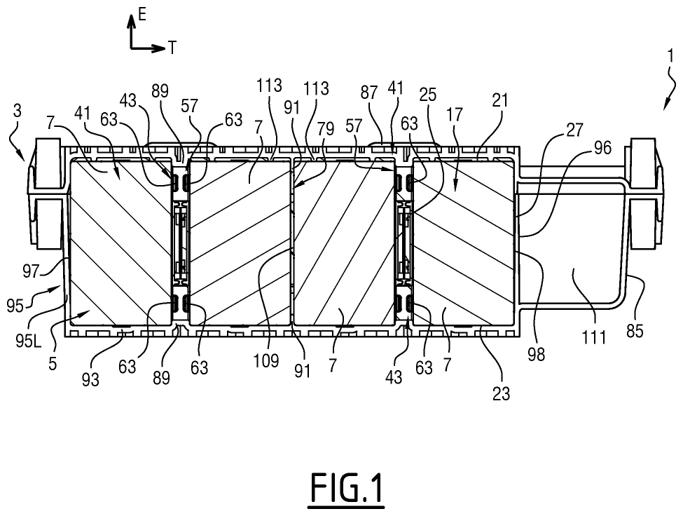

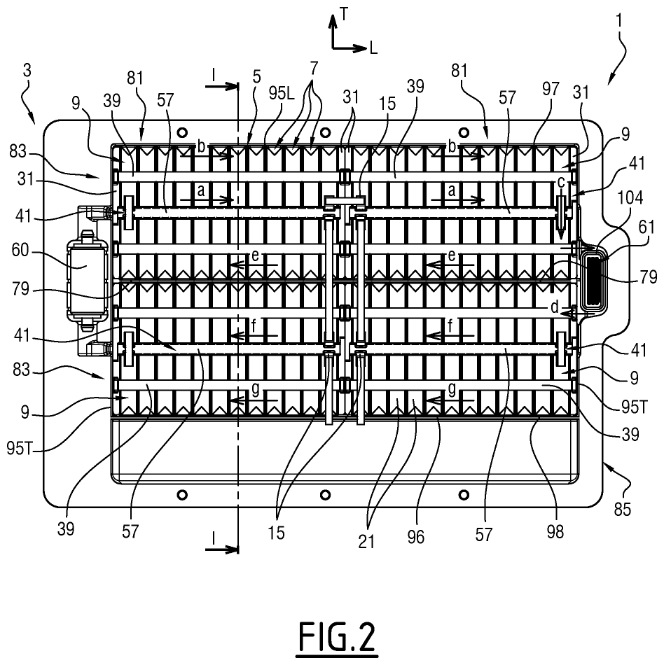

FIG. 1 is a sectional view of a first embodiment of the electric battery of the invention, taken according to the incidence of the arrows I in FIG. 2.

FIG. 2 is a top view of the electric battery of FIG. 1, the lid having been removed so as to reveal the internal structure of the battery.

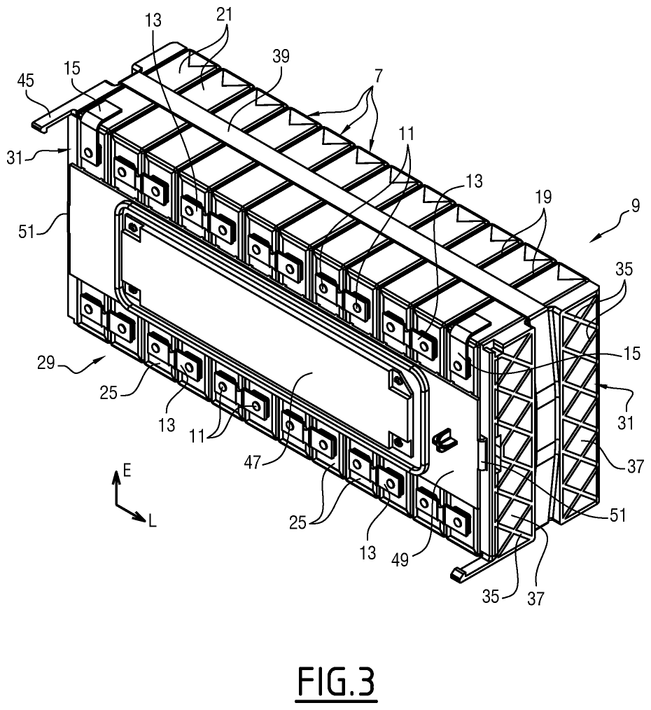

FIG. 3 is a perspective view of a module of the battery of FIGS. 1 and 2, equipped with its electronic balancing board.

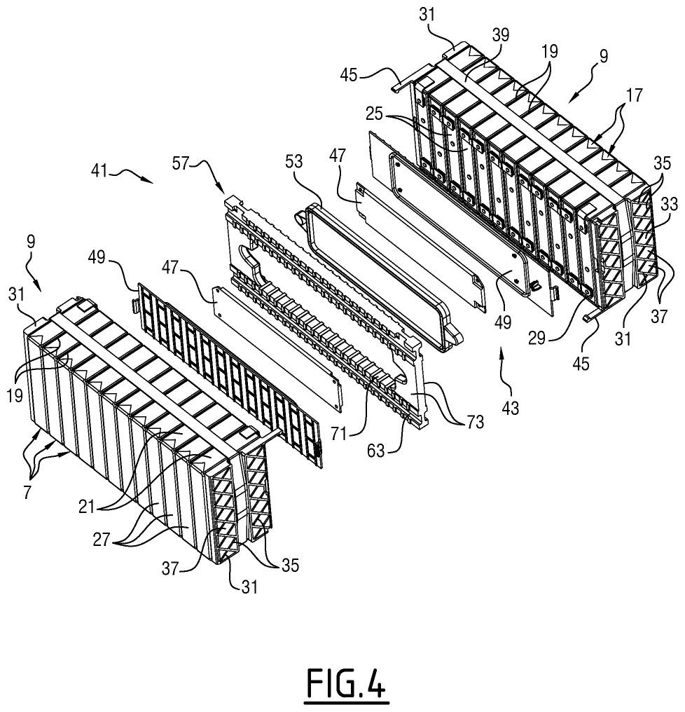

FIG. 4 is an exploded perspective view of an assembly of two modules of the electric battery of FIGS. 1 and 2, and of the fluid guide associated with this assembly.

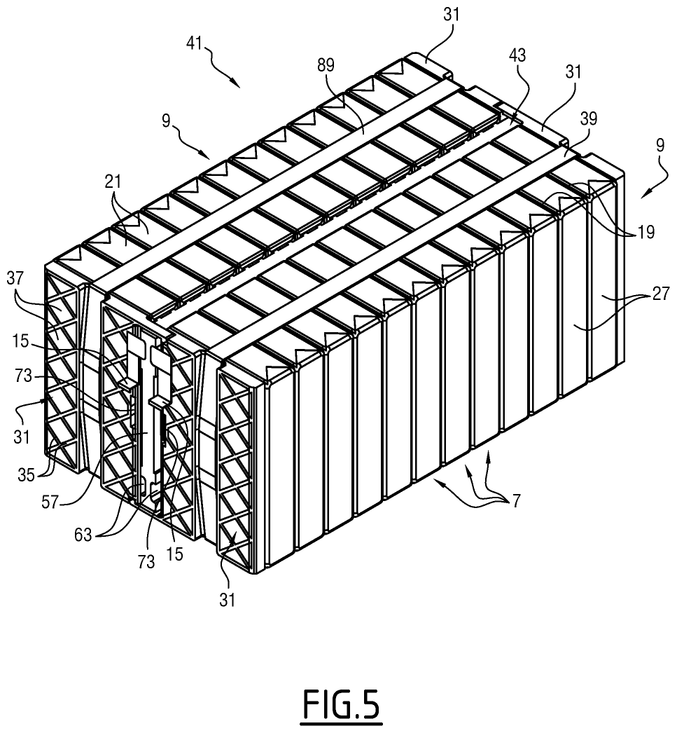

FIG. 5 is a perspective view, at a different angle of incidence, of the assembly of FIG. 4, in the assembled state.

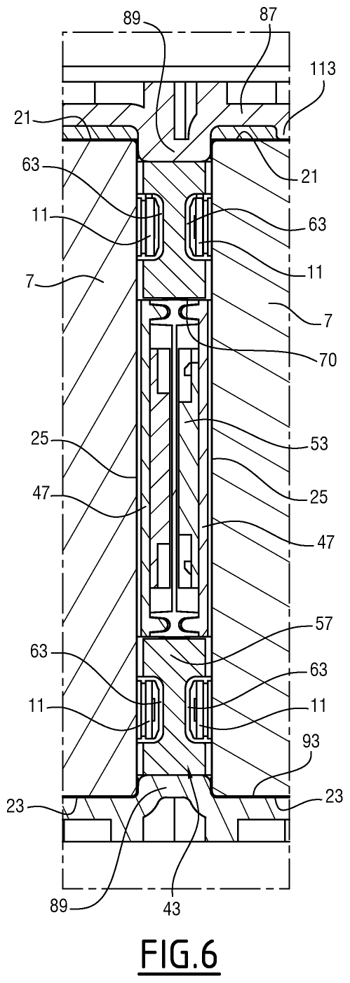

FIG. 6 is an enlarged sectional view of the gap between the two modules of the assembly of FIG. 5, showing the arrangement of the fluid guide.

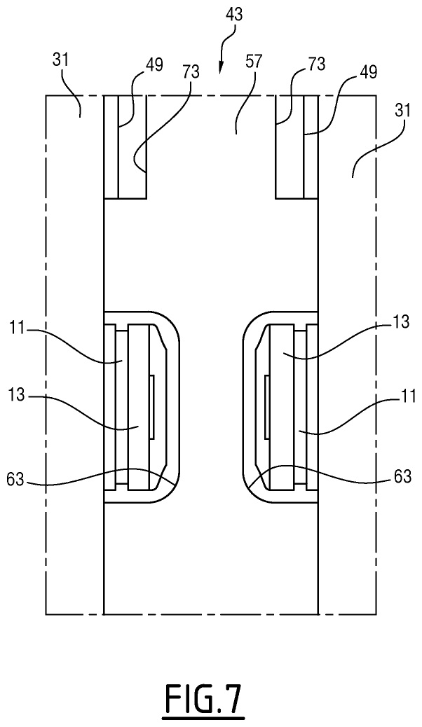

FIG. 7 is an enlarged sectional view of a detail of the gap and the fluid guide of the assembly of FIG. 5.

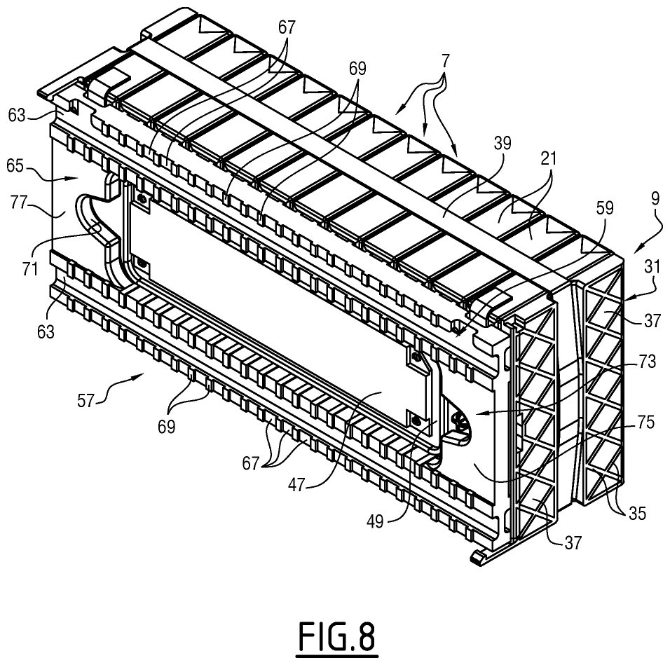

FIG. 8 is a view similar to FIG. 3, with the fluid guide shown pressed against the front face of the module.

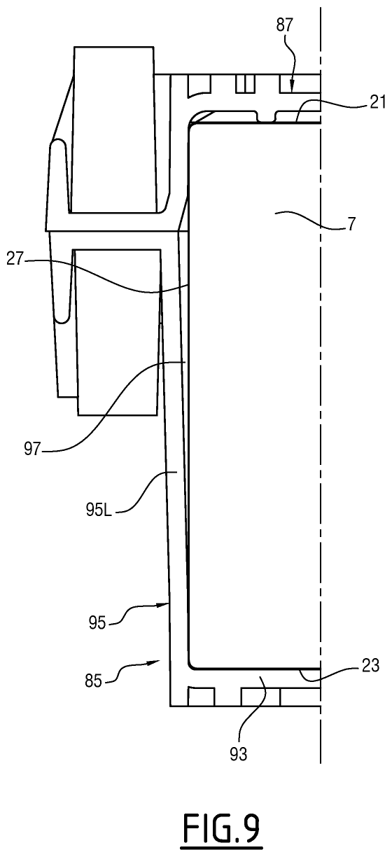

FIG. 9 is a sectional view of the side wall of the container.

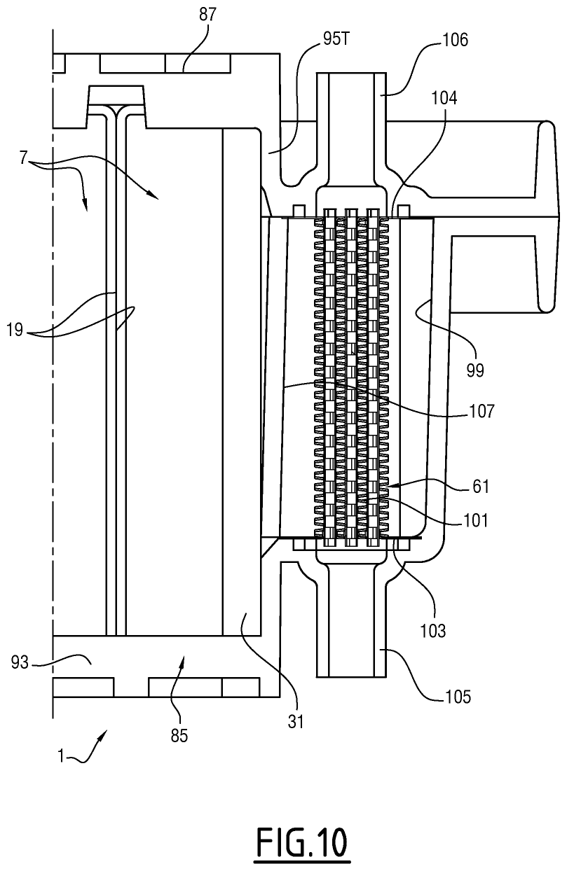

FIG. 10 is a sectional view of the heat exchanger fitted to the battery of FIGS. 1 and 2.

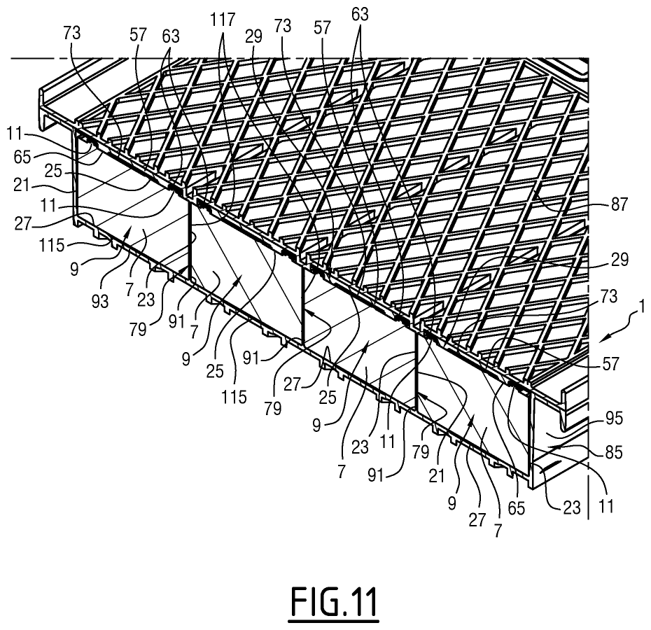

FIG. 11 is a sectional and perspective view of a battery according to a second embodiment of the invention.

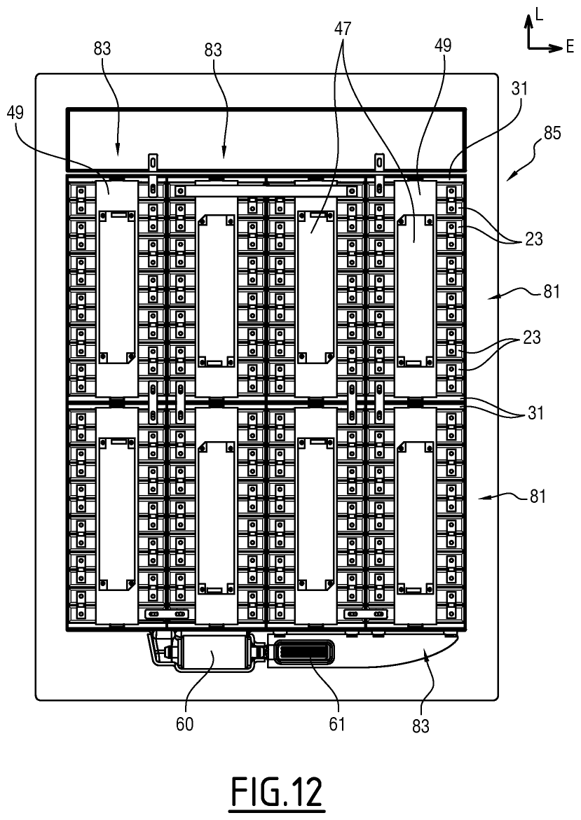

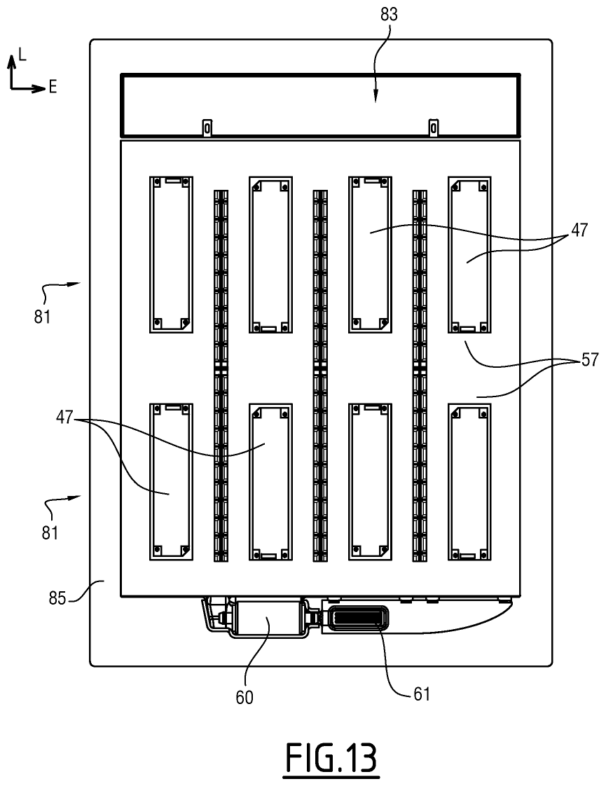

FIGS. 12 and 13 are top views of the battery of FIG. 11, without its lid, with FIG. 12 showing the battery modules without the fluid guide, and FIG. 13 with the fluid guide.

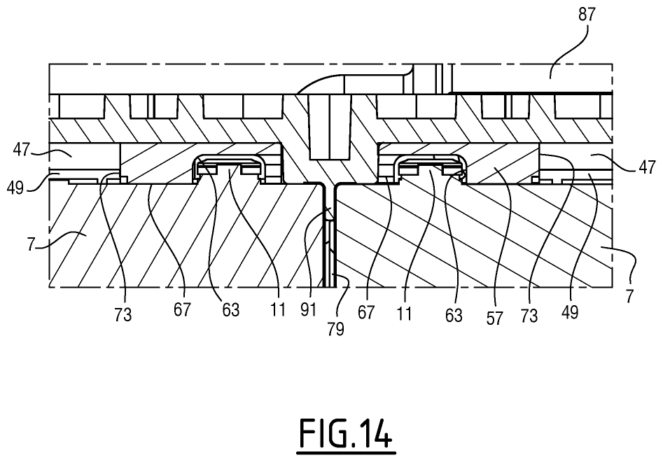

FIG. 14 is an enlarged sectional view of a detail of FIG. 11.

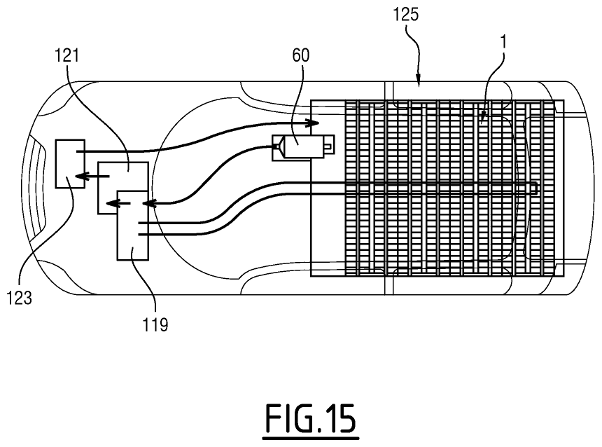

FIG. 15 is a simplified schematic representation illustrating an alternative embodiment of the invention applicable to the first and second embodiments.

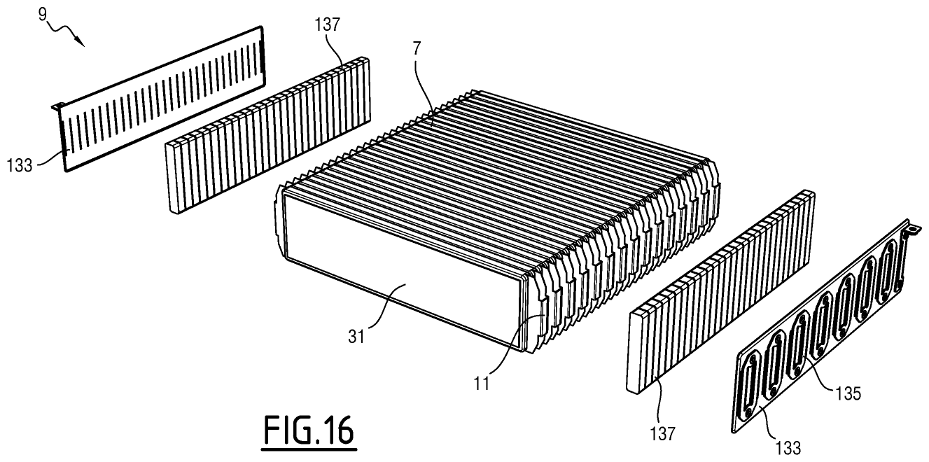

FIG. 16 is an exploded perspective view of a cell module according to a third embodiment of the invention.

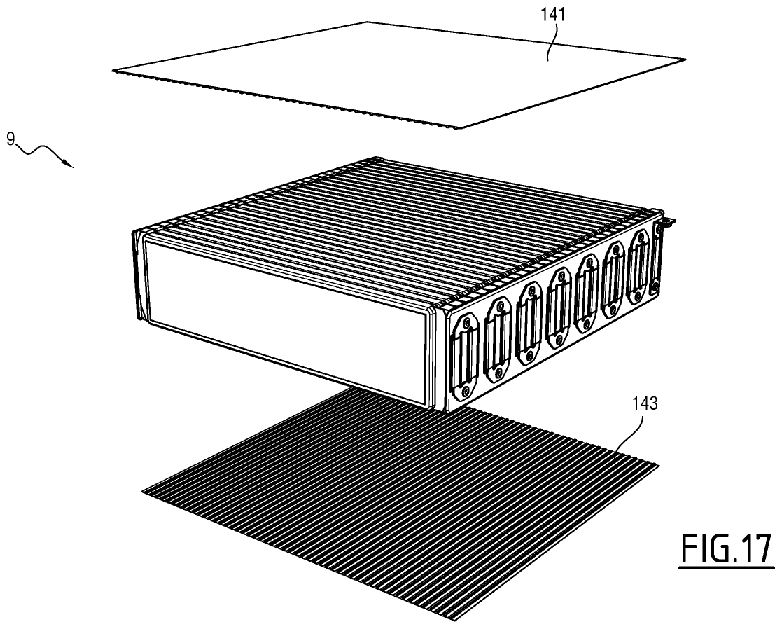

FIG. 17 is an exploded perspective view of the module of FIG. 16, partially assembled and completed.

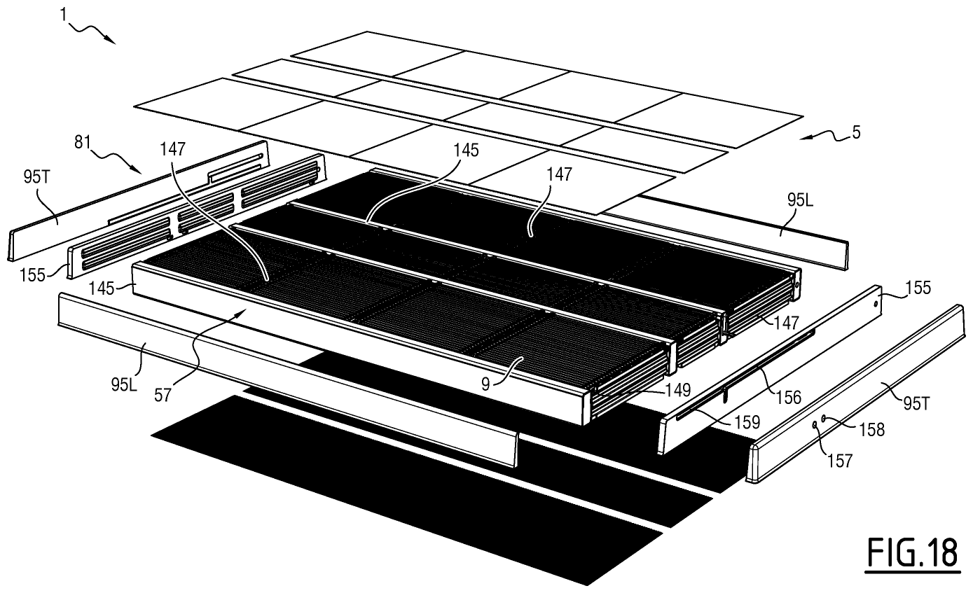

FIG. 18 is a perspective view, in part exploded, of a battery according to the third embodiment of the invention, including the module of FIG. 17; and

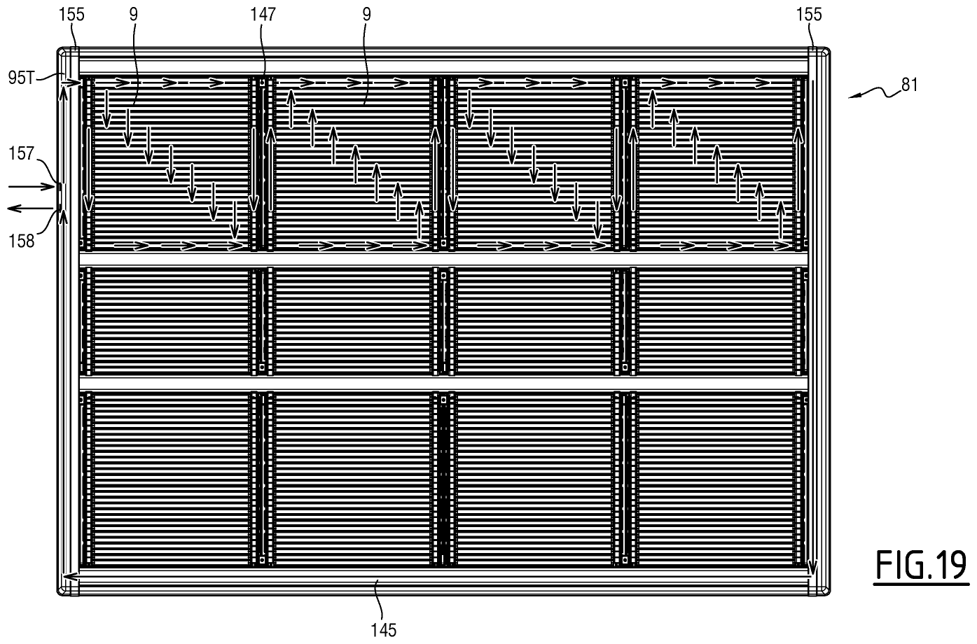

FIG. 19 is a top view of the battery of FIG. 18, showing fluid circulation in the battery.

The electric battery 1 shown in FIGS. 1 and 2 is intended to be fitted to a vehicle, typically a motor vehicle such as a car, bus, or truck.

The vehicle is for example a vehicle propelled by an electric motor; the motor being electrically powered by the electric battery. Alternatively, the vehicle is of the hybrid type, and thus comprises an internal combustion engine and an electric motor powered electrically by the electric battery. According to yet another variant, the vehicle is propelled by an internal combustion engine, the electric battery being provided to supply electrically other equipment of the vehicle, for example the starter, the lights, etc. . . . .

The electric battery 1 comprises a container 3, internally delimiting a sealed compartment 5, and a plurality of electricity storage cells 7 arranged inside the sealed compartment 5. The battery typically comprises a large number of electricity storage cells 7, typically several tens of electricity storage cells 7.

The electricity storage cells 7 are of any suitable type: lithium cells of the lithium-ion polymer (Li—Po), lithium iron phosphate (LFP), lithium cobalt (LCO), lithium manganese (LMO), nickel manganese cobalt (NMC), and nickel metal hydride (NiMH) type cells.

The storage cells 7 are distributed in one or more modules 9, typically in several modules 9.

In the example shown in FIGS. 1 and 2, the electric battery 1 has eight modules 9. Alternatively, the battery has a different number of modules 9: four, eight, twelve or any other number.

The number of modules 9 depends on the desired capacity of the battery 1.

In a single module 9, the electricity storage cells 7 are juxtaposed longitudinally. The longitudinal direction is represented by the arrow L in FIG. 2.

The electricity storage cells 7 have respective electrodes 11, typically two electrodes 11 per electricity storage cell.

The electrodes 11 of the electricity storage cells 7 in a single module 9 are electrically connected to each other in series and/or in parallel.

In the example shown in FIG. 3, the electrodes 11 of the electricity storage cells of the module 9 are connected by electrically conductive plates 13, so that the electricity storage cells 7 are placed in series. The module 9 also has two electrical connectors 15, which are connected to the electrodes 11 of the two end cells of the module 9, and constitute the electrical terminals for electrically connecting the module 9 to the current supply and discharge collectors.

As can be seen in the figures, the electricity storage cells 7 are typically prismatic cells, and each comprise a body 17 of generally parallelepipedal shape. The body 17 presents two side faces 19 opposite each other, top and bottom faces 21, 23 opposite each other, a front face 25 and a rear face 27 opposite each other. The side faces 19 are perpendicular to the longitudinal direction L. The top and bottom faces 21 and 23 are perpendicular to a direction of elevation, marked by the arrow E in FIGS. 1 and 3. The front and rear faces 25, 27 are perpendicular to the transverse direction, shown as arrow T in FIGS. 1 and 2.

The longitudinal direction L, transverse direction T and elevation direction E are perpendicular to each other.

The side faces 19 of the electricity storage cells 7 of a single module 9 are flat against each other, as shown in the figures. Each electricity storage cell 7 presents a height, taken along the direction of elevation E, much greater than its thickness taken along the longitudinal direction L.

The electrical connection electrodes 11 are carried by the front face 25 of each electricity storage cell 7. They are positioned at the two opposite ends of the front face 25, according to the direction of elevation E. They are typically aligned in two longitudinal lines, parallel to each other.

Each module 9 has a front face 29.

The front face 29 is formed by the front faces 25 of the electricity storage cells 7 of the module 9.

The front face 29 is substantially flat, and extends perpendicular to the transverse direction T.

Each module 9 also comprises two flanges 31, arranged at the two opposite longitudinal ends of the module 9. The electricity storage cells 7 are stacked longitudinally between the two flanges 31.

Each flange 31 comprises a substantially flat wall 33, perpendicular to the longitudinal direction L. This substantially flat wall 33 is in contact with the stack of electricity storage cells 7 by a large face. On its large face opposite the electricity storage cells 7, the substantially flat wall 33 carries stiffening ribs 35, delimiting between them recessed areas 37.

In the example shown, the recessed areas 37 are diamond shaped.

Each module 9 also has a strap 39, which connects the electricity storage cells 7 and the end plates 31 of the module 9.

The battery 1 comprises one or more assemblies 41, each assembly 41 comprising two modules 9 whose respective front faces 29 are arranged transversely opposite each other (see FIGS. 4 and 5). The front faces 29 define a gap 43 between them.

The gap 43 extends along the entire longitudinal length of the modules 9 and along the entire height of the modules 9 according to the elevation direction E. Each gap 43 is thus shaped like a slit having a small width taken along the transverse direction T in relation to its longitudinal length and its height according to the elevation direction E.

The end plates 31 of the two modules 9 of the same assembly 41 are rigidly fixed to each other by clips 45, which come from the end plates 31. The clips 45 make it possible to lock the modules 9 in position relative to each other in the transverse direction T.

The electric battery 1 comprises for each module 9 a circuit board 47, configured to balance the electrical load of the electricity storage cells 7 of the module 9 (FIGS. 3 and 4).

The circuit board 47 is attached to a support 49, which is itself snapped onto the end plates 31 by means of tabs 51. The circuit board 47 is, for example, a printed circuit board on a PCB (Printed Circuit Board). The board extends in a plane substantially perpendicular to the transverse direction T.

The support 49 is typically a plate made of a plastic material such as polypropylene. It extends in a plane perpendicular to the transverse direction T.

The circuit boards 47 and the supports 49 of the two modules of the assembly 41 are housed in the gap 43.

An intermediate plate 53 is interposed transversely between the two circuit boards 47. The intermediate plate 53 is provided to lock the circuit boards 47 in position and to electrically isolate them from each other.

In order to ensure the cooling of the electricity storage cells 7, a dielectric fluid (not shown) fills the sealed compartment 5.

The dielectric fluid is, for example, a liquid, in particular a coolant, fluorinated or not, or a mineral oil, or a modified vegetable oil.

The battery 1 further comprises at least one fluid guide 57 (FIGS. 4 and 6 to 8) made of a low-density plastic material, arranged inside the sealed compartment 5, the fluid guide 57 defining at least one flow channel 59 (FIGS. 6 to 8) for the dielectric fluid in contact with the electricity storage cells 7.

The electric battery 1 also comprises a device for circulating the dielectric fluid 60 (FIG. 2).

In order to ensure the removal of the heat given up by the electricity storage cells 7 to the dielectric fluid, the electric battery 1 also comprises a heat exchanger 61 (FIG. 10), having a circulation side for the dielectric fluid, and a circulation side for a heat transfer fluid.

Typically, the electric battery 1 comprises a fluid guide 57 for each assembly 41 of two modules 9.

The assemblies 41 and the fluid guides 57 are arranged inside the sealed compartment 5 to form a circuit for circulating the dielectric fluid in a closed loop between the device for circulating the dielectric fluid 60 and the heat exchanger 61.

The fluid guide 57 presents the general shape of a plate, arranged in the gap 43. Its function is to direct the dielectric fluid mainly in the area of the electrodes 11 of the electricity storage cells 7. The fluid guide 57 is shaped in such a way as to fill the gap 43 between the two modules 9 as much as possible, leaving free only the passages allowing the dielectric fluid to circulate in the desired zones.

The fluid guide 57 extends substantially over the entire longitudinal length of the gap 43 and substantially over the entire height of the gap 43 taken along the elevation direction E.

The fluid guide 57 is typically an injection molded part. The fluid guide 57 is typically made of a foam or expanded plastic material.

For example, the fluid guide 57 is made of expanded polystyrene, polyurethane foam, phenolic foam, thermoplastic foam. These foams are closed cell.

The at least one flow channel 59 comprises one or more electrode cooling channels 63, directing the dielectric fluid into contact with the electrodes 11 of the electricity storage cells 7.

As seen in particular in FIG. 8, the fluid guide 57 has two large faces 65, each facing one of the two modules 9. Each large face 65 faces one of the front faces 29 of the module 9. It faces the front face 29. Each large face 65 of the fluid guide 57 presents two electrode cooling channels 63, forming recessed reliefs on the large face 65 of the fluid guide 57.

In the example shown, where the electrodes 11 of the electricity storage cells 7 form two longitudinal lines, the electrode cooling channels 63 recessed in the same large face 65 of the fluid guide 57 are straight and longitudinal. They are arranged opposite the line of electrodes 11 of the electricity storage cells 7. In the direction of elevation E, they extend one above and the other below the support 49.

The electrodes 11 of the electricity storage cells 7 and the electrically conductive plates 13 are arranged in the electrode cooling channels 63, as visible in FIG. 7. The electrode cooling channels 63 extend longitudinally along the entire length of the fluid guide 57. They are open at each longitudinal end.

In order to cool the areas of each electricity storage cell 7 extending around the electrodes 11, the at least one flow channel 59 also comprises lateral branches 67, extending from the or each electrode cooling channel 63 along the direction of elevation E and directing the dielectric fluid into contact with the front faces 25 of the electricity storage cells 7.

These lateral branches 67 are visible in FIG. 8.

These lateral branches 67 are recessed areas separated from each other by ribs 69. For each electrode cooling channel 63, the fluid guide 57 comprises two series of lateral branches 67, arranged on either side of the electrode cooling channel 63. The lateral branches 67 of the same series are juxtaposed longitudinally and separated from each other by the ribs 69. Each lateral branch 67 presents a shallow depth, for example a depth of about 1 mm. The electrode cooling channels 63 present a greater depth than the side branches 67. The ribs 69 are intended to abut the front faces 25 of the electricity storage cells 7.

The dielectric fluid filling the side branches 67 thus contacts and cools the areas of the front faces 25 of the electricity storage cells 7 surrounding the electrodes 11.

The fluid guide 57 presents a central opening 71. The central opening 71 extends entirely through the fluid guide 57 from one large face 65 to the other. The electrode cooling channels 63 are located on either side of the opening 71 in the fluid guide 57, along the elevation direction E.

The intermediate plate 53 is arranged in the central opening 71, which presents substantially the same shape as this intermediate plate 53.

Along the transverse direction T, each of the circuit boards 47 is thus located substantially at the level of one of the large faces 65 of the fluid guide 57.

Advantageously, the at least one flow channel 59 comprises at least one circuit board cooling channel 73 (FIG. 8), directing the dielectric fluid into contact with at least one of the circuit boards 47.

In the illustrated example, the fluid guide 57 defines two circuit board cooling channels 73, each intended to cool one of the two circuit boards 47 belonging to the assembly 41.

The two circuit board cooling channels 73 are recessed into the two large faces 65 of the fluid guide 57. Each circuit board cooling channel 73 extends longitudinally along the entire length of the fluid guide 57. In the direction of elevation E, it extends substantially at the level of the corresponding circuit board 47. It is thus arranged between the two electrode cooling channels 63, along the elevation direction E.

The circuit board cooling channel 73 is recessed on the corresponding large face 65. It comprises an inlet section 75 extending from one longitudinal end of the fluid guide 57 to the central opening 71, and an outlet section 77 extending from the central opening 71 longitudinally to the other end of the fluid guide 57. It extends, along the elevation direction E, substantially over the entire height of the central opening 71 of the fluid guide 57.

The dielectric fluid can thus flow first along the inlet section 75, then around the circuit board 47 through the central opening 71 of the fluid guide 57, then along the outlet section 77 of the circuit board cooling channel 73.

The assemblies 41 are arranged inside the sealed compartment 5 parallel to each other. By this is meant that the assemblies 41 are arranged with the same orientation, with the respective longitudinal directions of the individual modules 9 being parallel to each other.

Typically, the assemblies 41 are arranged in at least one row 81, typically in several rows 81. Inside a single row 81, the assemblies 41 are juxtaposed along a juxtaposition direction. In the first embodiment, the juxtaposition direction corresponds to the transverse direction T.

Two assemblies 41 belonging to the same row 81 are separated by a space 79, as illustrated in FIGS. 1 and 2. This space 79 extends in a plane perpendicular to the direction of juxtaposition.

When the assemblies 41 are arranged in multiple rows 81, as shown in FIG. 2, the assemblies 41 in the different rows 81 are placed in line with each other longitudinally.

Each row 81 thus has the same number of assemblies 41.

In this case, the assemblies 41 of the different rows 81 are arranged in such a way as to form several lines 83, each line 83 comprising one assembly 41 of each row 81.

The assemblies 41 of the same line 83 are placed rigorously in the extension of each other along the longitudinal direction L. In particular, the interstices 43 of the assemblies 41 of the same line 83 are placed longitudinally in the extension of each other.

More specifically, the electrode cooling channels 63 of the assemblies 41 of the same line 83 are placed longitudinally in the extension of each other. The circuit board cooling channels 73 are also placed longitudinally in the extension of each other.

Furthermore, and as visible in FIG. 2, the spaces 79 of the different rows 81 are also longitudinally aligned and placed in the extension of each other.

As visible in FIG. 1, the container 3 comprises a bin 85 and a lid 87 assembled in a sealed manner with the bin 85.

Preferably, the bin 85 and/or the lid 87 are parts made of a composite material.

This material typically comprises a thermoplastic with short fibers, polypropylene, or another suitable material, if the mechanical stresses are sufficiently low.

Alternatively, the composite material is of the SMC type. It preferably comprises a thermoplastic or thermosetting material and a reinforcement. As an example, these reinforcements are fibers, a majority of the fibers being short fibers less than 51 mm (two inches) long. These short fibers are typically chopped fibers.

Long fibers are advantageously arranged at certain points, particularly certain points on the bottom 93 of the bin 85. They allow for local reinforcement of the bottom 93 of the bin 85. These long fibers have a length greater than 100 mm. These long fibers are also called continuous fibers.

Thus, in the material forming the bottom 93 of the bin 85, at least 50% by weight of the fibers are short fibers, and less than 50% by weight of the fibers are long fibers.

According to another variant, the composite material is of the RTM type.

Such a composite material preferably comprises a thermoplastic or thermosetting material and a reinforcement. As an example, this reinforcement may comprise fibers, a majority of the fibers being continuous fibers longer than 100 mm.

Thus, in the material forming the bin 85, at least 50% by weight of the fibers are continuous fibers. These fibers are advantageously arranged in several layers, with orientations chosen to obtain an excellent mechanical resistance depending on the stresses.

In either case, the thermosetting material is for example a polyester, a vinyl ester, an epoxy, an acrylic or a biosourced resin. The thermoplastic material is for example a synthetic or biosourced thermoplastic resin.

The reinforcement is, for example, a glass, basalt, carbon, aramid, or HMWPP (high molecular weight polypropylene) fiber. Alternatively, the reinforcement is flax, hemp, or is another biosourced fiber.

The bin 85 and lid 87 are concave pieces, with concavities facing each other. The bin 85 is relatively deeper than the lid 87.

The bin 85 and/or the lid 87 carry a plurality of longitudinal ribs 89, 91 blocking in translation the modules 9 perpendicularly to the longitudinal direction L, here along the juxtaposition direction. These ribs 89, 91 are visible in particular in FIG. 1.

Preferably, the said ribs are formed both on the tray 85 and on the lid 87.

The ribs 89 are engaged in the gaps 43 of each assembly 41. They extend along the entire longitudinal length of the gap 43. Transversely, they extend across the entire width of the gap 43 and are in nearly sealed contact with the front faces 29 of the two modules 9. The ribs 89 thus almost completely prevent the dielectric fluid flowing longitudinally in the gap 43 from escaping in the direction of elevation E, towards the bin 85 or towards the lid 87.

The ribs 91 are engaged in the spaces 79. They extend along the entire longitudinal length of the space 79. Along the transverse direction T, they extend over the entire width of the space 79 and are thus in sealing contact with the rear faces 27 of the electricity storage cells 7 arranged on either side of the space 79.

The rib 91 from the lid 87 thus closes in an almost sealed manner the space 79 along the elevation direction E, towards the lid 87. The rib 91 coming from the bin 85 closes the space 79 along the elevation direction E, towards the tray 85, in an almost sealed manner.

The bin 85 presents a bottom 93 and a peripheral side wall 95 integral with the bottom 93 (FIG. 9). The electricity storage cells 7 rest on the bottom 93 of the bin 85.

The peripheral side wall 95 flares slightly from the bottom 93 towards the lid 87. The taper angle is small and is typically a few degrees. Such a taper is necessary to allow the bin 85 to be removed from the mold during manufacturing.

The bin 85 also comprises a longitudinal internal partition 96.

The sealed compartment 5 is delimited on one side by a longitudinal portion 95L of the peripheral side wall 95 and on the opposite side by the longitudinal internal partition 96. It is also delimited by two transverse portions 95T of the peripheral side wall 95, extending in the direction of juxtaposition.

There is thus a longitudinal passage 97 between the longitudinal portion 95L of the peripheral side wall 95 and the rear faces 27 of the electricity storage cells 7 adjoining the said longitudinal portion 95L.

There is another longitudinal passage 98 between the inner longitudinal partition 96 of the bin 85 and the rear faces 27 of the electricity storage cells 7 adjoining the said inner partition.

In one embodiment example, the dielectric fluid circulation device 60 is located at one longitudinal end of the sealed compartment 5, and the heat exchanger 61 is located at the opposite longitudinal end of the sealed compartment 5.

The dielectric fluid circulation device 60 is, for example, a pump.

The heat exchanger 61 is arranged in a housing 99, provided in the peripheral side wall 95 of the heat exchanger 61 (FIGS. 2 and 10). This heat exchanger 61 comprises a plurality of finned tubes 101, comprising fins on the inside and outside. The coolant is arranged to flow inside the finned tubes 101, and the dielectric fluid outside.

The finned tubes 101 typically extend in a direction perpendicular to the bottom 93 of the bin 85, with the opposite ends of each finned tube 101 attached to grids 103, 104. A manifold 105, provided in the bin 85, distributes the coolant through the grid 103 to the individual finned tubes 101. A collector 106, provided in the lid 87, collects the coolant leaving the finned tubes 101 through the grid 104. Seals, not shown, are fitted between the grid 103 and the bin 85 and between the grid 104 and the lid 87. This ensures separation of the coolant from the dielectric fluid. Compression of the seals is ensured when the lid 87 is placed on the bin 85.

The grids 103, 104 and finned tubes 101 are made of aluminum.

A body 107 of a low-density plastic material is placed inside the housing 99, around the finned tubes 101.

This body 107 is typically made of the same material as the fluid guide 57. It allows the dielectric fluid to be directed along a pathway inside the sealed compartment 5 which will be described below.

In order to ensure the proper cooling of the electricity storage cells 7, the dielectric fluid fills all the free spaces of the sealed compartment 5.

However, the dielectric fluid is expensive, so it is particularly advantageous to limit the volume to be filled inside the sealed compartment 5 by the dielectric fluid.

One of the advantages of using the fluid guide(s) 57 is to reduce the volume to be filled by the dielectric fluid.

Thus, the plurality of electricity storage cells 7 occupy a volume called occupied volume. If the difference between the internal volume of the sealed compartment 5 and the occupied volume is called the remaining volume, the fluid guide(s) 57 occupy(s) at least 15% of the remaining volume.

Preferably, the fluid guide(s) 57 occupy between 20% and 80% of the remaining volume, and even more preferably between 40% and 60% of the remaining volume.

When the electric battery 1 comprises a single fluid guide 57, only the volume of the fluid guide 57 is considered for the above calculation. When the electric battery 1 comprises a plurality of fluid guides 57, the volume occupied together by all the fluid guides 57 is considered for the above calculation.

In order to further reduce the volume of dielectric fluid, the battery 1 preferably comprises at least one filler piece made of a low-density plastic material, arranged inside the sealed compartment 5, in the remaining volume.

The at least one filler piece is in addition to the fluid guide(s) 57.

The body 107, arranged around the finned tubes 101 of the heat exchanger 61 in the housing 99, is one of said filling parts.

Advantageously, further filling parts are arranged in the recessed areas 37, delimited between the stiffening ribs 35 of the flanges 31.

Preferably, a filler piece is provided in the longitudinal passage 97 existing between the side wall 95 of the bin 85 and the rear faces 27 of the electricity storage cells 7. This piece presents a wedge shape. It is provided in particular when the taper angle is high.

Advantageously, an additional fluid guide 109 made of a low-density plastic material is placed in each space 79. This additional fluid guide reduces the cross-sectional area offered to the dielectric fluid and directs the dielectric fluid to the areas of the back faces 27 of the electricity storage cells that are the hottest.

For example, the additional fluid guide 109 is located, along the elevation direction E, substantially in the middle of the electricity storage cells 7. The dielectric fluid will flow above and below the additional fluid guide 109 along the elevation direction E, i.e., in the areas at the electrodes along the elevation direction E.

The additional fluid guide(s) 109 are part of the filling parts.

Together, the fluid guide(s) 57 and the filling part(s) occupy at least 30% of the remaining volume, preferably at least 50%, and more preferably at least 80% of the remaining volume.

The filling part(s) alone preferably occupy between 15% and 60% of the remaining volume, more preferably between 20% and 40% of the remaining volume.

The filling parts are advantageously made of the same material as the fluid guide or guides 57.

The operation of the electric battery 1 will now be detailed.

The circulation device 60 delivers the dielectric fluid to the gap 43 of the assembly 41 located in the top line 83 in the representation of FIG. 2. The dielectric fluid circulates longitudinally, in the electrode cooling channels 63 and in the circuit board cooling channels 73 of the different assemblies 41 of this line 83. This circulation is shown by the arrow a in FIG. 2.

Some of the dielectric fluid circulates longitudinally in the longitudinal passage 97 between the peripheral side wall 95 of the bin 85 and the rear face 27 of the electricity storage cells 7 located opposite. This circulation is shown as arrow b in FIG. 2.

The dielectric fluid flows longitudinally from one end of the sealed compartment 5 to the other, and then is directed through the body 107 to the finned tubes 101 of the heat exchanger 61. This substantially transverse movement is represented by arrow c in FIG. 2.

Inside the heat exchanger 61, the dielectric fluid gives up some of its heat energy to the cooling fluid circulating inside the finned tubes 101. At the exit of the heat exchanger 61, the dielectric fluid is directed by the body 107 towards the space 79 and towards the gap 43 of the assembly 41 belonging to the bottom line 83 in the representation of FIG. 2.

The dielectric fluid exiting the heat exchanger 61 is shown as arrow d in FIG. 2.

Some of the dielectric fluid flows along the gaps 79 longitudinally from one end of the sealed compartment 5 to the other. This flow is shown as arrow e in FIG. 2. Other dielectric fluid circulates in the electrode cooling channels 63 and in the circuit board cooling channels 73, longitudinally, from one end of the sealed compartment 5 to the other. This circulation is shown as arrow fin FIG. 2.

Still other dielectric fluid flows along the longitudinal inner partition 96 of the bin 85, in the other longitudinal passage 98. This flow is shown as arrow g in FIG. 2.

The flows e, f and g then flow to the suction inlet of the pump 60.

The distribution of the dielectric fluid between the electrode cooling channels 63, the circuit board cooling channels 73 and the longitudinal passage 97 is modulated by playing on the cross-section of these different channels or passages. It is chosen according to the cooling needs of the areas of the electricity storage cells 7 served by dielectric fluid through these channels and passages.

In the same way, the distribution of the dielectric fluid, on return, between the space 79, the electrode cooling channels 63, the circuit board cooling channels 73, and the other longitudinal passage 98, is also modulated by playing on the passage sections offered to the dielectric fluid.

In particular, the presence of the additional fluid guide 109 makes it possible to reduce the quantity of dielectric fluid circulating in the space 79. Indeed, the width along the transverse direction of the space 79 is determined by the width of the ribs 91, which are at least 2.5 to 3 mm. Without the additional fluid guide 109, the amount of dielectric fluid flowing through the gap 79 would be too great.

Proper distribution of the dielectric fluid helps to limit thermal gradients in the electricity storage cells 7. This increases the lifetime of the electricity storage cells 7.

As seen in FIG. 1, the container 3 comprises an additional compartment 111, provided in the bin 85. This additional compartment 111 is separated from the sealed compartment 5, in which the electricity storage cells 7 are stored, by the longitudinal internal partition 96 of the bin 85. The additional compartment 111 of the container 3 typically contains various electronic components such as the isolation relays, the fuse, and the general management electronics of the battery 1. It is not normally filled with dielectric fluid. Alternatively, it is filled with dielectric fluid.

The volume of the sealed compartment 5, in which the electricity storage cells 7 are housed, is closed by the lid 87. This is fixed to the bin 85 for example by a sealant, guaranteeing an excellent seal. This sealant is, for example, polyurethane.

The additional compartment 111 of the container 3 is preferably not closed by the lid 87 but by an additional lid, not shown, which is independent of the lid 87 and is fixed to the container 85 by removable fasteners such as screws. Indeed, the electronic components housed in the additional compartment 111 of the container 3 are much more likely to require servicing than the components stored in the sealed compartment 5. It is therefore preferable that the electronic components be easily accessible and removable.

According to an alternative embodiment, the circuit boards 47 are not housed in the internal volume of the sealed compartment 5 but are housed in the additional compartment 111 of the container 3.

They are therefore more easily accessible for maintenance.

Another variant will now be described.

In FIG. 1, it can be seen that the lid 87 has, in addition to the ribs 89 and 91, stiffening ribs 113. These stiffening ribs 113 are clearly visible in FIG. 6. They typically come to rest on the upper faces 21 of the electricity storage cells 7. In order to further reduce the volume of dielectric fluid filling the container 3, the volumes located between the stiffening ribs 113, or between the stiffening ribs 113 and the ribs 89, 91, are filled with fillers made of a low-density plastic material, typically the same plastic material as that constituting the fluid guide(s) 57.

In the same way, the bottom 93 of the bin 85 advantageously comprises, towards the interior of the internal volume of the sealed compartment 5, stiffening ribs. The electricity storage cells 7 rest on these ribs by their respective lower faces 23. Preferably, the volumes located between the said stiffening ribs, or between the stiffening ribs and the ribs 89, 91, are filled with fillers made of a low-density plastic material, typically the same material as that constituting the fluid guides 57.

A second embodiment of the invention will now be described, with reference to FIGS. 11 to 14.

Only the points in which this second embodiment differs from the first embodiment, corresponding to FIGS. 1 to 10, will be detailed. The elements that are identical or perform the same functions in both embodiments will be designated by the same references.

The second embodiment differs from the first one mainly by the orientation of the electricity storage cells 7. In the second embodiment, as illustrated in FIGS. 11 and 14 in particular, the front face 25 of each electricity storage cell 7 faces the lid 87. Each electricity storage cell 7 rests on the bottom 93 of the bin 85 by its rear face 27.

The modules 9 are no longer assembled two by two to form sub-assemblies 41.

The modules 9 are arranged in several rows 81, the modules 9 being juxtaposed according to a juxtaposition direction within the same row 81. The modules 9 are also organized into a plurality of rows 83, each row 83 comprising one module 9 from each row 81. Inside a single row 83, the modules 9 are placed in longitudinal extension of each other. The direction of juxtaposition corresponds here to the direction of elevation E.

The fluid guides 57, which direct the circulation of the dielectric fluid in contact with the electrodes 11 and in contact with the circuit boards 47, are interposed between the lid 87 and the front faces 29 of the various modules 9.

They comprise cooling channels for the electrodes 63 and the circuit boards 73 only on one of their large faces 65, turned towards the front face 29 of the corresponding module 9.

Advantageously, the fluid guides 57 associated with the various modules 9 are formed by a single plate, made of low-density plastic material (FIG. 13).

This single plate covers the front faces 29 of all the modules 9, as illustrated in FIGS. 11 and 13.

In the embodiment example shown in FIGS. 11 to 14, the heat exchanger 61 and the dielectric fluid circulation device 60 are arranged at a same longitudinal end of the sealed compartment 5. The outlet of the heat exchanger 61 is directly connected to the suction inlet of the dielectric fluid circulation device 60.

It should be noted that the bottom 93 of the bin 85 comprises in this embodiment hollow channels 115 (FIG. 11), allowing the dielectric fluid to circulate in contact with the rear faces 27 of the electricity storage cells 7.

The modules 9 in a single row 81 are separated from each other by spaces 79. Filling pieces 117 are placed in these spaces 79, so as to prohibit or limit the presence of dielectric fluid in these spaces 79.

Ribs 91, extending from the bottom 93 of the bin 85, are engaged in the spaces 79 and allow blocking of the translation of the modules 9 along the direction of juxtaposition.

The lid 87 does not have any ribs 91, particularly in the case where the various fluid guides 57 are made of a single plate.

Alternatively, as shown in FIG. 14, the lid 87 carries ribs 91 engaged in the spaces 79. In this case, the fluid guides 57 are typically independent of each other.

An alternative embodiment is shown in FIG. 15. It is applicable to the two embodiments described above, namely the embodiment of FIGS. 1 to 10 and the embodiment of FIGS. 11 to 14.

In this embodiment, the dielectric fluid is an oil.

This oil is used to cool a power electronics 119, and/or an electric motor 121. In addition, or instead, the oil is cooled or heated by a heat pump 123 or is cooled by the vehicle's front-end radiator or air conditioning unit. The front radiator and the air conditioning unit are not shown. In addition, or instead, the oil lubricates the electric motor 121. Thus, the oil may be used to cool and lubricate the electric motor 121.

In this alternative embodiment, the battery 1 is not equipped with a heat exchanger 61.

The invention also relates to a vehicle 125 comprising an electric battery 1 having the above features (FIG. 15).

The electric battery 1 is, for example, configured to electrically power an electric motor for propulsion of the vehicle. This motor is for example the electric motor 121 described above.

The vehicle comprises power electronics 119 associated with the motor 121. The dielectric fluid of the battery 1 is an oil, which is advantageously used to cool and/or lubricate the electric motor 121, and/or to cool the power electronics 119.

In addition, or instead, the oil is cooled or heated by a vehicle heat pump 123 or is cooled by the vehicle's front-end radiator or air conditioning unit. The front radiator and air conditioning unit are not shown.

The electric battery described above has multiple advantages.

As mentioned above, the fluid guide(s) made of low-density plastic allows the circulation of the dielectric fluid filling the sealed compartment to be organized, so as to preferentially cool the areas depending on their cooling needs. Furthermore, the fluid guide reduces the quantity of dielectric fluid used to fill the sealed compartment, which is particularly economical.

The volume occupied by the fluid guide(s) is incredibly significant, the saving being therefore substantial.

The construction of the fluid guide(s) is particularly easy when the low-density plastic material is a foam or expanded plastic material. Such materials are particularly well suited for the realization of a fluid guide intended to be arranged in an electric battery.

The ribs in the bin and/or the lid for locking the modules in translation allow the modules to be locked in position in the event of impacts, in a direction perpendicular to the longitudinal direction. In case of impact, each module is supported on one of the ribs coming from the bin and/or one of the ribs coming from the lid.

Some modules are supported on the ribs 89, engaged in the gaps 43. Other modules are supported on the ribs 91 engaged in the spaces 79.

Indeed, in case of impacts, it is possible to have a deceleration up to 40 G.

The ribs allow this load to be distributed. In the absence of these ribs, the different modules are supported by each other, so that the load transferred to the side wall of the container is considerable.

Moreover, this would lead to a crushing of the fluid guides located in the interstices 43. These fluid guides could no longer be made of low-density plastics such as foam or polystyrene. It would be necessary to make them out of heavy and expensive, but more rigid plastics.

The circulation channels for the dielectric fluid make it possible to concentrate the circulation of the dielectric fluid in particular on the electrodes of the electricity storage cells, on the areas of the electricity storage cells carrying the electrodes, or even on the circuit boards provided for balancing the electrical load of the various electricity storage cells of the same module.

These channels also allow for a looped circulation from the circulation device 60 to the heat exchanger 61 and back.

The balancing of the flow rates in contact with the different zones to be cooled is achieved in a particularly convenient way, by playing on the passage sections offered to the dielectric fluid. In particular, additional filling pieces, made of low-density plastic, can be added to modulate the flow of the dielectric fluid in certain zones.

This limits the temperature gradients inside the electricity storage elements, which is favorable for their life span.

The battery can also comprise other low-density plastic fillers at various points inside the sealed volume to further reduce the volume of dielectric fluid used.

The battery can have multiple variations.

The number of electricity storage cells, modules and subassemblies can vary widely. FIG. 2 shows a bin with ninety-six 3.65-volt Li-Ion electricity storage cells connected in series. This provides a potential difference of 350 volts.

These electricity storage cells are assembled in eight sets of two modules each. The sets are divided into two rows 81 of two sub-sets 41.

If one hundred and ninety-two electricity storage cells are required in parallel series, allowing the same potential difference but twice the energy storage capacity, the battery has sixteen modules divided into eight sets of two modules.

In this case, the sets 41 can be arranged in two rows 81 of four sets 41, thus forming four lines 83.

The pump and heat exchanger can be arranged in multiple ways. The circulation of the dielectric fluid is arranged according to the respective positions of the circulating device and the heat exchanger. For example, the four lines are supplied with dielectric fluid in parallel. An upstream manifold distributes the dielectric fluid leaving the pump to the different assemblies at one end of the tank. At the opposite longitudinal end, a downstream collector collects the dielectric fluid and leads it to the heat exchanger. The outlet of the heat exchanger is directly connected to the suction inlet of the circulation device.

Alternatively, the dielectric fluid at the pump discharge is distributed in two lines. It flows longitudinally in one direction along these two lines and then returns to the heat exchanger by flowing in the other two lines longitudinally in the opposite direction. The outlet of the heat exchanger is connected directly to the pump suction inlet.

According to yet another possible configuration, the eight assemblies 41 are arranged in four rows 81 of two assemblies 41, and thus form two lines of four assemblies. The two lines are supplied in parallel. The dielectric liquid exiting the circulation device is distributed by an upstream manifold to both lines and flows longitudinally from one edge of the compartment to the other in both lines. At the opposite longitudinal edge, it is collected by a downstream collector and returned to the heat exchanger. The outlet of the heat exchanger is connected directly to the suction inlet of the circulation device.

An electric battery 1 according to a third embodiment of the invention is shown in FIGS. 16 to 19. In these figures, the elements similar to the preceding figures are designated by identical references.

According to this second embodiment, the electricity storage cells 7 are of the pouch cells type, and not prismatic cells as previously described. Such pouch cells 7 generally comprise two flat lateral faces and have a relatively small thickness separating the two flat lateral faces.

FIG. 16 shows a module 9 comprising a set of pouch cells 7 juxtaposed parallel to each other, i.e., their flat side faces are all arranged parallel.

Each pouch cell 7 comprises electrodes 11. The module 9 comprises connection plates 133, comprising connectors 135, arranged on either side of the pouch cell assembly 7. The electrodes 11 are electrically connected to the connectors 135. The connectors 135 are made of aluminum, for example.

The module 9 also comprises spacer elements 137, each arranged between the pouch cell assembly 7 and a respective one of the connection plates 133. This spacer 137 also extends between the electrodes.

Each spacer element 137 is generally made of expanded plastic, such as polystyrene. Each spacer element 137 forms a fluid guide as defined above, comprising at least one channel for circulation of the dielectric fluid. These spacer elements 137 reduce the amount of dielectric fluid in the module 9, as compared to a similarly sized module without such spacer elements 137.

The spacer elements 137 are sized to leave a clearance between the electrodes 11 and these spacer elements 137, to allow the circulation of the dielectric fluid. The dielectric fluid thus circulates in contact with the electrodes 11, which makes it possible to cool them while they are heated, in particular by Joule effect, by the passage of electricity through these electrodes 11.

Optionally, the module 9 comprises a plurality of cooling flanges 31 arranged parallel to the pouch cells 7, each in contact with one of the pouch cells 7 or a pair of the pouch cells 7. Each cooling flange 31 is for example made of polyurethane foam but may alternatively be formed of any suitable material (e.g., extruded plastic or corrugated sheet metal), and comprise channels allowing the circulation of oil along the flat faces of the pouch cells 7.

As shown in FIG. 17, the module 9 also comprises upper 141 and lower 143 plates closing this module 9, perpendicular to the flat faces of the pouch cells 7. These upper 141 and lower 143 plates are for example made of extruded plastic.

The upper and lower plates 141 and 143 each present an internal surface (turned towards the pouch cells 7) provided with grooves allowing the circulation of the dielectric fluid, but also with projecting and flat parts allowing the mechanical support of the lower and upper edges of the pouch cells 7. These upper and lower plates 141 and 143 generally present a flat external surface.

The electric battery 1 is formed by an assembly of such modules 9. This assembly of modules 9 is arranged in a sealed compartment (not shown).

As in the previous embodiments, fluid guides 57 occupy the free spaces of the sealed compartment 5.

In particular, the fluid guides 57 comprise longitudinal beams 145, extending parallel to the longitudinal side walls 95L. Two longitudinal beams 145 are each arranged between a respective one of the longitudinal walls 95L and the set of modules 9. Furthermore, the other longitudinal beams 145 are each interposed between two adjacent rows 81 of the modules 9.

The fluid guides 57 also comprise transversal beams 147, arranged perpendicularly to the longitudinal beams 145, separating the modules 9 in the same row from each other.

The longitudinal beams 145 are preferably hollow and filled with expanded plastic. These longitudinal beams 145 are for example made of metal material.

The transversal beams 147 are preferably, as shown, made of a sheet of metal stiffened by grooving, but they may alternatively be hollow and filled with plastic if the strength of the single sheet is not sufficient.

The beams 145, 147 also comprise, on their faces facing the modules 9, expanded plastic plates 149, so that the electrodes 11 are not in contact with the beams 145, 147. These plates 149 also allow the longitudinal wedging of the modules 9.

The beams 145, 147 are pierced with channels for the circulation of the dielectric fluid.

The fluid guides 57 also comprise intermediate plates 155 interposed between the transverse side walls 95T and the modules 9. These intermediate plates 155 comprising dielectric fluid circulation channels 156.

Furthermore, at least one of the transverse side walls 95T comprises at least one passage opening 157 for introducing the dielectric fluid into the electric battery 1. This passage opening 157 communicates with the circulation channels 156, in order to direct and distribute the dielectric fluid in the electric battery 1.

This same transversal side wall 95T (or alternatively the other transversal side wall 95T) also comprises an outlet opening 158.

The rows 81 of modules 9 are supplied with dielectric fluid through openings 159 in the circulation channels 156 of the intermediate plates 155.

The flow of dielectric fluid through a row 81 of modules 9 is shown in FIG. 19.

The dielectric fluid is introduced into the battery 1 through the inlet opening 157. The dielectric fluid is then directed through the circulation channels 156, to the openings 159, through which it enters a first module 9 of the row 81.

The dielectric fluid then spreads along this module 9, on the one hand, longitudinally, along the flanges 31, and transversally along the upper and lower plates 141 and 143, until it reaches the end of the module 9.

It will be recalled that, because of the clearance between the electrodes 11 and the spacer 137, the dielectric fluid also circulates partly in contact with the electrodes 11.

The entire module 9 is thus bathed in the dielectric fluid and this dielectric fluid is in motion throughout the module 9 to remove the heat emitted by the pouch cells 7. The size and arrangement of the channels in the corrugated plates, the shape of the spacers, and the plates allow the flow rates to be balanced as required.

Then, the dielectric fluid is directed by the transverse beam 147 between this module 9 and the next one, before circulating in this next module 9 in the same way as in the previous one.

The dielectric fluid thus travels longitudinally through the entire row 81, until it reaches the intermediate plate 155 at the other end, where it is guided by the circulation channels 156 of this intermediate plate 155 to at least one of the longitudinal beams 145, which it travels longitudinally through until it returns to the first intermediate plate 155, where the dielectric fluid will be directed to the outlet opening 158. Alternatively, the dielectric fluid is guided back through a plurality of longitudinal beams 145.

It will be noted that, in either embodiment, the spirit of the invention is to fill the cavities of the battery 1 with low-density plastic material (polystyrene or the like), with the dielectric fluid passage being provided in cavities provided in the various elements of this material.

What is claimed:

1. An electric battery for a vehicle, the electric battery comprising:
a container, internally delimiting a sealed compartment;
a plurality of electricity storage cells arranged inside the sealed compartment, the electricity storage cells having respective electrodes; and
a dielectric fluid filling the sealed compartment;
at least one fluid guide made of a low-density plastic material, arranged inside the sealed compartment, the fluid guide defining at least one flow channel for the dielectric fluid in contact with the electricity storage cells;
a device for circulating the dielectric fluid.

2. The battery according to claim 1, wherein the sealed compartment presents an internal volume, the plurality of electricity storage cells occupying an occupied volume, a remaining volume being equal to the internal volume minus the occupied volume, the at least one fluid guide occupying at least 30% of the remaining volume.

3. The battery according to claim 1, wherein the low-density plastic is a foam or expanded plastic.

4. The battery according to claim 1, wherein
the electricity storage cells are distributed in one or more modules, the electricity storage cells of a single module being longitudinally juxtaposed and having a front face.

5. The battery according to claim 1, wherein the at least one flow channel comprises at least one electrode cooling channel, directing the dielectric fluid into contact with the electrodes of the electricity storage cells.

6. The battery according to claim 5, wherein the electricity storage cells are distributed in one or more modules, the electricity storage cells of a single module being longitudinally juxtaposed and having a front face and wherein the electricity storage cells of the same module each presents a front face elongated along a direction of elevation and carrying the electrodes of the said electricity storage cell the front faces together constituting the front face, the at least one flow channel comprising lateral branches extending from the or each electrode cooling channel in the direction of elevation and directing the dielectric fluid into contact with the front faces of the electricity storage cells.

7. The battery according to claim 1, wherein the electricity storage cells are distributed in one or more modules the electricity storage cells of a single module being longitudinally juxtaposed and having a front face and wherein the electric battery comprises for each module a circuit board configured to balance an electric load of the electricity storage cells of the said module, arranged opposite the front face of the module, the at least one flow channel comprising at least one circuit board cooling channel directing the dielectric fluid in contact with at least one of the circuit boards.

8. The battery according to claim 1, wherein the electricity storage cells are distributed in one or more modules, the electricity storage cells of a single module being longitudinally juxtaposed and having a front face and wherein the battery comprises two modules whose respective front faces are arranged transversely opposite each other and delimit a gap between them, the fluid guide forming a spacer defining a transverse width of the gap.

9. The battery according to claim 1, wherein the electricity storage cells are distributed in one or more modules, the electricity storage cells of a single module being longitudinally juxtaposed and having a front face and wherein the container comprises a bin and a lid connected in a sealed manner to the bin, the bin and/or the lid carrying a plurality of longitudinal ribs translationally blocking the modules perpendicular to the longitudinal direction.

10. The battery according to claim 1, wherein the battery comprises at least one filler piece made of a low-density plastic material, arranged inside the sealed compartment in the remaining volume so as to decrease the volume of dielectric fluid required to fill the sealed compartment.

11. A vehicle comprising an electric battery according to claim 1.

12. The vehicle according to claim 11, wherein the electric battery is configured to electrically power an electric motor for propulsion of the vehicle.
